(19) United States
(12) Patent Application Publication
(10) Pub. No.: US 2008/0185870 A1
(43) Pub. Date: Aug. 7, 2008

(54) Vehicle With an Additional Cargo Carrier Located in the Rear Area

(76) Inventors: Alain Leroy, Diessen-Dettenschwang (DE); Heinz Pschorn, Dachau (DE); Robert Braun, Berg (DE); Dirk Legler, Weil (DE); Michael Koelbl, Neuried (DE); Oliver Vogt, Munchen (DE); Thomas Rudolph, Hechendorf (DE); Thomas Jakimenczuk, Hohenkirchen (DE)

Correspondence Address: DICKINSON WRIGHT PLLC, 1901 L. STREET NW, SUITE 800, WASHINGTON, DC, 20036, US

(21) Appl. No.: 11/908,365

(22) PCT Filed: Mar. 10, 2006
(86) PCT No.: PCT/DE2006/000438

§ 371 Date: Oct. 23, 2007

(30) Foreign Application Priority Data
Mar. 11, 2005 (DE) 10 2005 011 682.5

(51) Int. Cl. B60R 9/00; B62D 33/00

(52) U.S. Cl. 296/182.1

(57) ABSTRACT

The invention relates to a vehicle with a rear area in which an additional cargo carrier is integrated, comprising a gate, which can pivot about an axis and which, when open, defines an approximately horizontal plane. In addition, a transport module (11) is provided, which can be placed on the cargo support (10) or is mounted thereon and which has means specifically designed for holding and/or fastening certain types of cargo.

The present invention relates to a vehicle with a rear area into which an additional cargo carrier is integrated, comprising a hatch placed so as to pivot about an axis, which, when open, defines an approximately horizontal plane.

From the state of the art, hatches for vehicles have become known in which an additional cargo carrier is integrated into the hatch. For example, DE 44 24 611 describes a vehicle with a hatch in which an additional pivoting lid is integrated into the hatch, whereby this lid can be pivoted out into an approximately horizontal utility setting, and means for attaching various loads such as profile rails and a carrying bar are placed on the upper side of the pivoted lid, so that bicycles can be transported on the pivoted-out surface. In the retracted position, this cargo carrier is integrated into the hatch so that its outer side lies snugly against the frame of the hatch. However, the hatch is embodied with two walls, whereby the retracted cargo carrier forms one exterior wall and in addition another interior wall of the hatch lies within, which encloses the actual storage space in the interior of the vehicle toward the outside. It is thus not possible to use the cargo carrier to make room for transported goods in the interior of the vehicle, since the hatch remains closed in both settings of the cargo carrier.

DE 42 31 568 A1 describes a luggage carrier for vehicles in which, in a similar manner, an extendable flap is integrated into the hatch. Here also, when the lid that serves as an additional cargo carrier is extended, the hatch itself remains closed, so that the storage area is not accessible. One alternative embodiment version makes provision that a bumper unit can be pulled out rearwards, by which the vehicle is lengthened and an additional cargo carrier is provided.

From U.S. Pat. No. 1,588,740, an extendable cargo carrier that lengthens the rear area is known. In this device, a lengthened loading surface and an additional loading space is created in the rear area. Here, initially a customary trunk hatch is pivoted upwards. After that, the box-like luggage carrier, similar to a drawer, is pulled outwards, whereby an additional rounded door is present that lengthens the hatch downwards when the trunk is closed. This additional door can be pivoted and then can be folded rearwards. By sliding the box in after loading, it is possible to bring loaded goods into the trunk. However, this principle is not readily transferable to vehicles with a hatch that pivots as a rule about an axis in the upper area, different from a trunk hatch in a vehicle with a notchback. With this known solution, for an extended cargo carrier, the hatch is opened, and the extended position is not provided as a rule for a road load. Additionally, a danger exists that exhaust gases will get into the vehicle's passenger compartment.

FR 2745772-A1 describes a vehicle with a hatch that can be pivoted out from a vertical closed setting. The vehicle in question is a small car. To increase the volume of the trunk, provision is made that when the hatch is pivoted out, an additional trunk is created by placing additional loaded goods on the swiveled out lid. To prevent this from falling down, for delimitation the storage space, a device made of multiple limiting plates connected so as to pivot with each other is provided, whereby this device is reinforced by rods that are attached on the vehicle. The device comprises lateral plates, plates running at a slant and a central rear plate. The additional storage space thus created ought also to be suitable to accommodate loads during the vehicle's trip. The device is of an unstable and improvised nature and would not meet modern requirements in regard to safety in road traffic. Also it is relatively difficult to bring the device into the utility setting. The loading space produced on the lid is open toward the top, so that the loaded goods are unprotected in this respect. Additionally, when the lid is opened, the entire trunk is exposed. The solution is provided for small vehicles with a customary trunk, but not for a station wagon with a loading space closed by a trunk lid, which is connected to the passenger compartment of the vehicle and thus makes possible storage of long loads, for example.

The task of the present invention is to make available a vehicle with a rear area into which an additional cargo carrier is integrated, which makes possible safe and convenient transport of additional loaded goods in the rear area. The loading capacity is increased, and it is easily possible to load and unload the expanded loading area.

The solution to this problem provides an invention-specific vehicle with a rear area into which an additional cargo carrier is integrated, according to the type mentioned initially with the characterizing features of the main claim. According to the invention, at least one transport module, able to be placed on the cargo carrier or attached to the cargo carrier, is provided, which exhibits means that are specifically embodied to accommodate and/or attach certain transported goods.

Thus the invention offers the user a possibility to bring the cargo carrier in the rear area into a pivoted-out utility position, and to transport additional goods, for example, that the passenger compartment of the vehicle will not accommodate, such as skis, bicycles or the like. As part of the invention, the most varied transport modules may be made available, in each case adapted to the goods to be transported. If loose goods or small parts are to be transported, a box-like container is especially suitable as a transport module. This can be a rigid transport box, or also a so-called pop-up box, that can be folded out from a flat, folded-together unused state to a box-like container. This has an advantage in that when not used, this folding box hardly takes up any space in the cargo area of the vehicle. The invention-specific solution preferably provides that when a load carrier is pivoted out, it is sealed via a partition toward the passenger compartment of the vehicle, so that exhaust gases are prevented from penetrating into the vehicle's passenger compartment during the trip.

A transport box embodied as a box-like container can, for example, have a foldable hatch, so that the transport box is filled from the upper side. The hatch can be provided with a locking device that can be combined with the vehicle's central locking system, so that when the vehicle is parked, the transport box can be secured against unauthorized access.

According to a possible alternative embodiment version of the invention, a box-like container, that is open on the side facing the vehicle space, also offers a possibility to increase the vehicle's load volume. Such a transport box can be used as a sleeping compartment when the vehicle is parked, for example.

One additional possible embodiment alternative of the invention makes provision that a transport module can be pushed in from an exterior position in which it is on the pivoted-out cargo carrier, preferably along guide media in the passenger compartment, or pulled out from the vehicle's passenger compartment. This version, for example, offers the possibility to easily load the passenger compartment, especially with a heavy item of goods.

A further possible alternative embodiment version makes provision that two pivoting hatches are placed above each other in the vehicle's rear area. The lower hatch then serves as a cargo carrier able to be swiveled out, but extends over only a part of the height of the vehicle's rear. This lower hatch makes possible easy loading of the lower area of the vehicle's passenger compartment. If this lower area is filled with goods, then via an additional upper pivoting hatch, a separate access to the vehicle's passenger compartment can be created, so that with the lower hatch closed, the remaining storage area in the upper part of the passenger compartment can easily be unloaded respectively. Especially favorable conditions are created if the two hatches pivot in opposite directions.

The invention-specific transport module or one of these transport modules can be acquired with the vehicle by the acquiring party. In this case, at least one transport module is already preferably integrated into the cargo carrier embodied as a pivotable hatch. However, it can also be well provided that only the pivotable cargo carrier is present, and one or more transport modules are acquired as accessory parts. With this it is in turn possible that the transport modules can either be carried in the vehicle and mounted if needed on the cargo carrier, or the user mounts an appropriate transport module once using suitable attaching elements on the cargo carrier, and then this is always available.

The features named in the subordinate claims related to preferred additional embodiments of the invention-specific task solution. Further advantages of the invention come from the detailed description that follows

In what follows, we describe the present invention in greater detail using the embodiment examples, with reference to the appended drawings. Shown are:

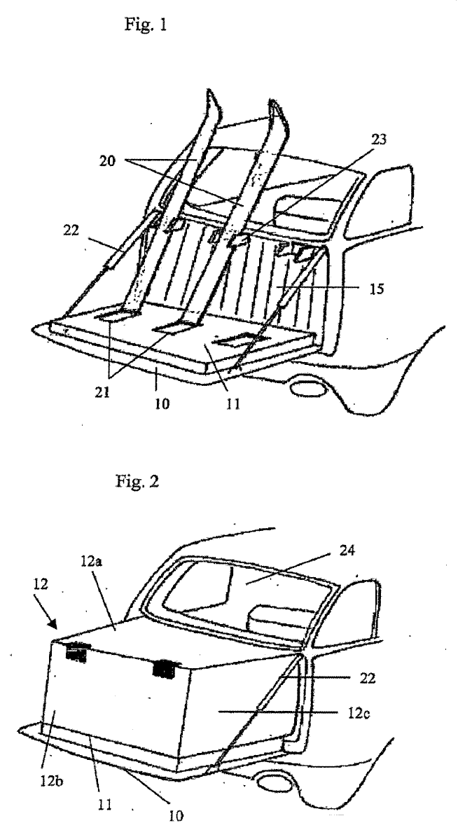

FIG. 1: a schematically simplified view of a rear area of a vehicle with a cargo carrier according to a first version of the invention,

FIG. 2: a similarly schematically simplified view of the rear area of a vehicle with a cargo carrier according to a second version of the invention,

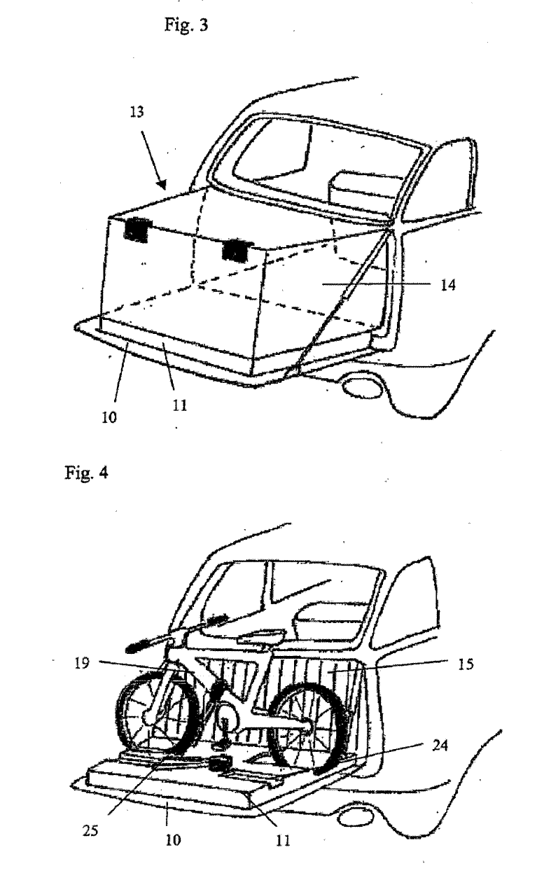

FIG. 3: a similarly schematically simplified view of the rear area of a vehicle with a cargo carrier according to an additional version of the invention,

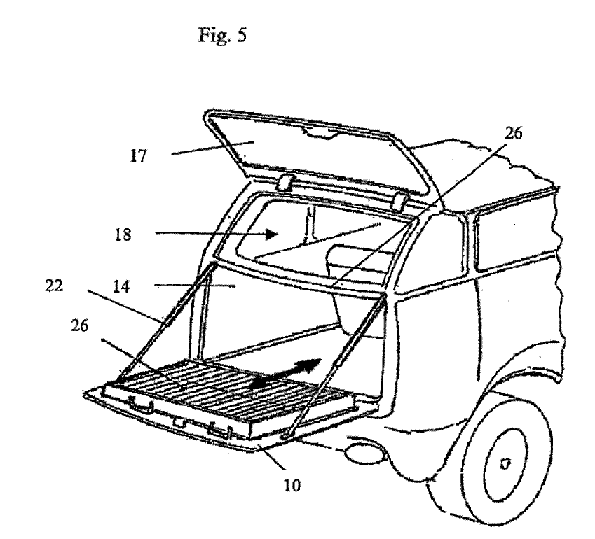

FIG. 4: a further schematically simplified view of the rear area of a vehicle with a cargo carrier according to an alternative version of the invention,

FIG. 5: a further schematically simplified view of the rear area of a vehicle with a cargo carrier according to an alternative version of the invention.

Reference is initially made to FIG. 1. In a drastically simplified view, the depiction shows a rear area of a vehicle, whereby here only the rear area is shown, along with those parts of the vehicle that are significant to explain the present invention. In the meaning of the present invention, what serves as a cargo carrier is a hatch 10 placed in the rear area that can be pivoted about a horizontal axis, which [hatch] can be pivoted out into a roughly horizontal utility position, which is depicted in FIG. 1. In the normal unused setting, the hatch 10 preferably lies in an area of the vehicle's rear that is roughly snug against the adjoining area of the chassis. According to a preferred version of the invention, arresting devices 22 can be provided, which ensure that hatch 10 is arrested in the roughly horizontal utility setting depicted in FIG. 1. These arresting devices 22 can simultaneously act as accumulators, and serve to facilitate the pivoting of hatch 10 into the unused setting. For example, for this, gas pressure springs or other spring elements can be used as arresting devices 22.

As the utility setting according to FIG. 1 shows, the pivoted-out hatch 10 serves as a cargo carrier, whereby a transport module 11 is provided, which can either be present as an integral component part of the hatch in the vehicle already, or such a transport module 11 can if necessary be acquired subsequently by the vehicle owner, and placed on the cargo carrier 10 and be attached to it. For this, appropriate attachment devices serve, which are not depicted in FIG. 1. According to the invention, there is an advantage in that transport module 11 has means that are specifically configured to admit and/or attach certain transported goods. This means, in the embodiment example according to FIG. 1, a roughly plate-shaped, comparatively flat transport module 11, on which recesses 21 or receptacles are embodied on the upper side (visible side), into which skis 20 can for example be inserted. At another place, for example on a frame brace of the vehicle's rear, additional holders 23 are placed, which are for example embodied as clamping devices, so that the skis 20 inserted into the receptacles 21 can be secured in these holders. The invention-specific idea provides that transport module 11 if necessary can be replaced, so that the user can also place another transport module on the hatch-shaped cargo carrier 10, in order to transport other loads, such as bicycles, as this is shown in the embodiment version according to FIG. 4.

FIG. 4 shows an embodiment version similar to FIG. 1, in which a hatch-shaped cargo carrier 10 is likewise provided, on which there is a relatively flat plate-like transport module 11, which either is an integral component part of cargo carrier 10, or can be acquired as an additional part and can be attached onto cargo carrier 10. Transport module 11 is thus replaceable in the last-named case. Transport module 11 provided to transport bicycles 19 according to FIG. 4 has appropriately adapted receptacles 24, that in this case extend in a direction transverse to the vehicle, whereby preferably at least two such receptacles 24 are placed in a row, so that, as FIG. 4 depicts, the rear wheel or the front wheel of a bicycle 19 can be inserted there. Preferably, several such rows, each having two receptacles 24 are present, so that several bicycles 19 can be attached on transport module 11. Preferably additional attachment devices are provided in the form of holding elements 25, which make it possible to safely secure the bicycles 19 during the trip. These holding elements 25 can, for example, be on transport module 11 and be pivoted up by swiveling from a flat unused setting into the utility setting shown in FIG. 4.

In other respects, in both of the embodiment version according to FIGS. 1 and 4, provision is made that a partition 15 cuts off access to the vehicle's passenger compartment, especially to the cargo area of a station wagon, for example, so that it is sealed, which prevents vehicle exhaust gases from penetrating into the vehicle's passenger compartment. This ensures that when cargo carrier 10 is in the folded out setting, driving can be done without exhaust gases penetrating into the vehicle. For this, preferably the partition 15 is not necessarily a rigid separating wall, but rather, for example, a sealed film curtain or a partition able to be pivoted or removed, so that there is also access to the vehicle's cargo area for loading other goods with cargo carrier 10 pivoted out.

The advantage in the invention-specific solution according to the versions as per FIG. 1 and 4 is that the vehicle owner thus has a vehicle in which the traditional loading functions of a station wagon, for example, are obtained and the cargo space is fully available, whereby the cargo space is accessible by opening the hatch that also serves as a cargo carrier 10. In addition, the user also has an option to transport specific loads if he pivots cargo carrier 10 out into a roughly horizontal utility setting, and uses an appropriate transport module 11, which is adapted to the particular transported goods and has appropriate attachment elements and holders. It can also run with a pivoted-out cargo carrier 10 and owing to the sealed partition 15, exhaust gases cannot get into the vehicle's interior. Nonetheless, the user does not have the disadvantage present in traditional solutions that there is a rigid closed wall that is virtually a component part of the chassis instead of partition 15, and thus would prevent loading of the remaining storage space in the vehicle's passenger compartment. In contrast to traditional vehicles with a notchback and trunk, the invention-specific solution retains the option to slide long cargo items through the partition, embodied, for example, as a flexible film curtain, or after removal of partition 15, into the vehicle's passenger compartment.

In what follows, reference is made to FIG. 2, which shows an alternative version of the invention-specific solution. Here also the hatch-like pivotable cargo carrier 10 is present, which can be pivoted out into a roughly horizontal utility setting, in which it is held by the arresting devices 22. On the cargo carrier 10, a transport module 12 embodied as a transport box can either be placed directly, which is attached to the cargo carrier, or provision can be also made that a flat transport module 11 is already on cargo carrier 10, which is embodied to be plate-shaped and comparatively flat, similar to the embodiment examples as per FIGS. 1 and 4. In the latter case, box-like container 12 is placed on a flat transport module 11, so that it is also possible, after removal of transport box 12, to transport another load carrier, which is attached to the flat, plate-shaped transport module 11 (see FIGS. 1 and 4).

The transport box 12 depicted in FIG. 2 preferably encloses a closed cuboid container with side walls 12c, a rear wall 12b that runs in the vehicle's transverse direction, as well as a lid 12a, that shuts transport box 12 at the top, whereby the lid preferably can be opened by pivoting about an axis. For this, for example, hinges 23 can be present, as shown in FIG. 2. But it is also possible that the pivoting axis of the lid is on the side turned toward the vehicle, and instead of that, locks 23 are provided, after the opening of which, lid 12a can be opened by pivoting clockwise in the drawing. The advantage with this version of the solution is that with transport box 12, the user has a relatively large transport container with a large loading volume. This can be a rigid box that can, for example, be carried along in the vehicle when not used. However, instead of that, according to a preferred version, the transport box 12 is embodied as a type of pop-up box, which is in a flat unused state and has appropriate folding walls, and can be brought by pushing up into the utility setting depicted in FIG. 2, in which, if necessary, it is stabilized by reinforcing elements not shown here. In the version as per FIG. 2, preferably transport box 12 is closed by an appropriate rear wall toward the vehicle's passenger compartment, so that exhaust gases cannot get into the passenger compartment, and the user can drive with no difficulties with the transport box 12 attached to the cargo carrier 10. But provision can also be made that behind transport box 12, a flexible or removable partition 15 is found of the type depicted in FIGS. 1 and 4, so that the vehicle's passenger compartment is also sealed even if transport box 12 has no rear wall.

A further alternative embodiment version of a similar transport box that is designated with reference number 13, is shown in the embodiment example according to FIG. 3. With this version, the transport box deliberately has no rear wall, so that its side facing the passenger compartment 14 is open. With this version also, the transport box is placed on cargo carrier 12 or on a transport module 11 that is located on it, or transport box 12 is a folding box or pop-up box, which is virtually integrated into a transport module 11 on cargo carrier 10, and can be folded up into the utility setting shown in FIG. 3. With the last-named version, the transport box 13 can always be brought along by the user, and if necessary can already be a component part of the acquired vehicle. First the user swings out the hatch-shaped cargo carrier 10 placed in the vehicle's rear area, and then folds up the folding box 13 located in transport module 11, and secures it in the unfolded utility setting using fixing or reinforcement elements not depicted here, such as rods. The version shown in FIG. 3 can be used while the vehicle is in motion, to create an expanded cargo space, since here there is no connection between the passenger compartment of a station wagon, for example, and the additional cargo space formed by transport box 13. Thus, the vehicle can also be loaded from the interior. This merely presupposes that transport box 13 has been embodied to be sufficiently stable to transport the items accommodated therein. But, as an alternative to this, provision can also be made that the transport box 13 embodied, for example, as a folded box, can be used as a sleeping compartment in a parked vehicle, since an extended lying surface is produced by transport box 13. For this, the floor surface in the interior of box 13 preferably lies in a plane to the floor of the vehicle's passenger compartment, so that an extended lying surface can be created roughly along the length of cargo carrier 10.

In what follows, with reference to FIG. 5, a further alternative embodiment version of the invention is explained in greater detail. In this version, again, a hatch-shaped configured cargo carrier 10 is situated so as to be pivoted about an axis in the vehicle's rear area, whereby FIG. 5 shows the pivoted-out utility setting. Here also, preferably arresting devices 22 are present, to hold cargo carrier 10 in the pivoted-out utility setting. On the cargo carrier there is a relatively flat transport module 16, which, however, is not attached permanently in this embodiment version to cargo carrier 10, but rather is placed so as to slide in the vehicle's longitudinal direction according to the drawn arrow. This means that the transport module can be slid in from the position shown in FIG. 5, in which it is on cargo carrier 10 outside the vehicle, in the arrow direction into the passenger compartment (cargo area) of the vehicle. This is advantageous, for example, if one places loads onto transport module 16 which are comparatively heavy or bulky. In this case, the transport module 16 serves as a loading aid, and facilitates insertion of loads into passenger compartment 14 through the opening when hatch 10 is opened. And vice versa, one can naturally also make use of transport module 16 for unloading deposited loads on it from the interior of the vehicle. For this, transport module 16 with the load place on it, can be slid outward in the arrow direction from the vehicle's interior on cargo carrier 10, and the load can be taken out. Transport module 16 can, for example, also be a transport box shown in a flattened position in FIG. 5, which, similar to the pop-up box described using the embodiment versions of FIGS. 2 and 3, can be unfolded from a flat state. By this means a transport box is created, which likewise can be slid from the interior of the vehicle outward, or from the position on cargo carrier 10 into the vehicle's interior.

The embodiment example according to FIG. 5 shows still another alternative version of the invention. As can be seen, above the hatch-shaped cargo carrier 10 an additional pivotable hatch 17 is placed. This hatch 17 is embodied so as to pivot about a preferably horizontal pivoting axis situated in the over rear area, whereby this hatch 17, in the opened state depicted in FIG. 5, encloses a further loading opening 18. In this embodiment version, hatch 17 also covers the vehicle's rear window pane, for example. Beneath hatch 17 lies the opening 18, which has an advantage in that an additional upper loading opening 18 is created, which then makes possible easy loading, for example, of additional loads, if the load area 14 beneath is filled with loads to an extent that the opening behind hatch 10 to the lower loading area is no longer accessible. Through the additional opening 18 long cargo items, for example, can also be loaded into the passenger compartment of an already loaded station wagon.

As can be seen from FIG. 5, the vehicle's rear area is virtually divided so that two separate loading openings 18, 14 result, that are separated from each other, for example, by a horizontal frame strut 26. The upper opening is closed by the pivotable hatch 17. The lower opening is closed by the cargo carrier 10 embodied as a pivotable hatch. Cargo carrier 10 thus forms a pivotable hatch that extends over only a part of the height of the rear area as far as frame strut 26. Preferably the pivoting axes of the two hatches 10, 17 are so arranged that the hatches pivot in opposing directions for opening. It is advantageous if the pivoting axis of the upper hatch 17 lies in the area of an upper transverse frame brace and the lower pivoting axis for cargo carrier 10 runs somewhat above the bumper or the rear valence. The version according to FIG. 5 is also advantageous if transport module 16 is embodied as a foldable transport box or if a transport box 12, 13 according to the embodiment examples of FIG. 2 or 3 is provided. Also in these instances, the user, by means of a hatch 17 in the type shown in FIG. 5, has the option to load the vehicle's passenger compartment via an additional loading opening 18. The versions of the invention shown in the various embodiment examples according to FIGS. 1 to 5 can also sensibly be combined with one another. The loading concept in these vehicles is very variable. The particular transport modules can either be acquired with the vehicle or subsequently purchased as separate parts and attached to the vehicle or placed on the cargo carrier. For attachment of the particular transport modules, the vehicle's existing locks can be used, particularly the lock to close the cargo carrier 10 embodied as a pivotable hatch. If an additional hatch 17 of the type shown in FIG. 5 is present, a separate lock is likewise provided for this as a rule. It makes sense for the locks for hatch 17 or the hatch-shaped cargo carrier 10 to be operable via the vehicle's central locking device, so that a radio key can be used, for example, to operate them. Transport modules 11, 12, 13, 16 can be secured via the locks provided for hatches 10, 17, to prevent unauthorized removal.

### LIST OF REFERENCE SYMBOLS

10 Hatch

11 Transport module

12 Transport box

12a Lid

12b Rear wall

12c Side walls

13 Transport box

14 Passenger compartment

15 Partition

16 Transport module

17 hatch

18 Loading opening

19 Bicycles

20 Skis

21 Recesses

22 Arresting equipment

23 Holders

24 Receptacles

25 Holding elements

26 Frame brace

1. Vehicle with a rear area into which an additional cargo carrier is integrated, comprising a hatch placed so as to pivot about an axis, which defines a roughly horizontal plane in a pivoted-out state,
characterized in that additionally a transport module (11) is provided that can be place on or attached to the cargo carrier (10), which has means that are specifically embodied to receive and/or attach certain transported goods.

2. Vehicle with a rear area according to claim 1, characterized in that the transport module (11) has means to receive and/or attach bicycles.

3. Vehicle with a rear area according to claim 1, characterized in that the transport module is a container which can be folded out from a flat, folded-up state to a box-like container (pop-up box).

4. Vehicle with a rear area according to claim 1, characterized in that the transport module (11) has means to receive and/or attach skis.

5. Vehicle with a rear area according to claim 1, characterized in that the transport module (12) is a box-like container which, on all sides, and also on the top, is closed or closable, and/or which has a rear-side partition sealed toward the vehicle's passenger compartment.

6. Vehicle with a rear area according to claim 5, characterized in that the box-like container (12) has a cover (12a) able to be folded out.

7. Vehicle with a rear area according to claim 5, characterized in that the box-like container (13) is closed or closable on the sides and top, and is open on the side (14) facing the vehicle compartment and thus forms a closed loading area that expands the vehicie's passenger compartment beyond the length of the vehicle.

8. Vehicle according to claim 1 or 2, characterized in that with the transport module (11 ) placed on the swiveled-out luggage carrier (10) a partition (15) is provided that seals toward the passenger compartment of the vehicle.

9. Vehicle with a rear area according to one of claims 1 to 8, characterized in that at least two different transport modules (11) are provided, that optionally can be used and are provided for the receipt and/or attachment of various loaded goods and can be placed on the cargo carrier (10).

10. Vehicle with a rear area according to one of claims 1 to 9, characterized in that the transport module (16) placed on the pivoted-out cargo carrier (10) preferably can be slid in along guiding apparatus into the passenger compartment (14) or can be pulled out of it.

11. Vehicle with a rear area according to one of claims 1 to 10, characterized in that the cargo carrier (10) embodied as a pivotable hatch extends only over a part of the vehicle's rear and an additional pivotable hatch (17) is placed over the cargo carrier in the upper area of the rear, which encloses an opening (18) with separate access to the passenger compartment (14) of the vehicle.

12. Vehicle with a rear area according to claim 11, characterized in that the upper hatch (17) pivots about an upper pivoting axis into the open setting in a direction opposite to the hatch (10) comprising the cargo carrier.

13. Vehicle with a rear area according to one of claims 1 to 12, characterized in that attachment elements for attaching the transport module are provided on the luggage carrier (10) and/or the transport module (11).
